(19) United States
(12) Patent Application Publication
(10) Pub. No.: US 2023/0203986 A1
(43) Pub. Date: Jun. 29, 2023

(54) EXHAUST GAS RECIRCULATING DEVICE FOR GAS TURBINE ENGINE

(71) Applicant: HONDA MOTOR CO., LTD., Tokyo (JP)

(72) Inventor: Daisuke SATO, Saitama (JP)

(21) Appl. No.: 17/971,833

(22) Filed: Oct. 24, 2022

(30) Foreign Application Priority Data
Dec. 27, 2021 (JP) 2021-212068

(51) Int. Cl. F02C 3/34; F02C 7/141; F02C 7/18

(52) U.S. Cl. CPC F02C 3/34; F02C 7/141; F02C 7/18; F05D 2260/213; F05D 2260/232; F05D 2260/60

(57) ABSTRACT

An exhaust gas recirculation device for a gas turbine engine (10) includes an exhaust gas recirculation passage (32) for supplying a part of exhaust gas discharged from a combustor (18) of a gas turbine engine to the combustor, an air-cooled cooler (34) provided in the exhaust gas recirculation passage for cooling the exhaust gas flowing through the exhaust gas recirculation passage by heat exchange with ambient air, and an oil-cooled cooler (36) provided in the exhaust gas recirculation passage downstream of the oil-cooled cooler for cooling the exhaust gas flowing through the exhaust gas recirculation passage by heat exchange with lubricating oil of the gas turbine engine.

### TECHNICAL FIELD

The present invention relates to an exhaust gas recirculating device for a gas turbine engine.

### BACKGROUND ART

In the field of gas turbine engines, it is known to provide an exhaust gas recirculation device to reduce NOx in the exhaust gas discharged from the gas turbine engine by recirculating a part of the exhaust gas to the intake system. See JP5715753B2 (U.S. Pat. No. 8,015,822B2), for example. In such exhaust gas recirculation devices for gas turbine engines, it is also known to cool the recirculated exhaust gas so that the exhaust gas supplied to the intake system may not adversely affect the combustion process of the gas turbine engine. See JP5787838B2 (U.S. Pat. No. 9,217,367B2), for example.

Since the temperature of the exhaust gas discharged from the gas turbine engine is high, a relatively large cooling device is required to cool the recirculated exhaust gas to a temperature that does not adversely affect the combustion process of the gas turbine engine. However, providing a large cooling device undesirably increases the cost and weight of the exhaust gas recirculation system, and impairs space efficiency.

### SUMMARY OF THE INVENTION

In view of such a problem of the prior art, a primary object of the present invention is to provide an exhaust gas cooling device for a gas turbine engine that can cool the recirculated exhaust gas to a required temperature without undesirably increasing the size and weight of the cooling device.

To achieve such an objection, the present invention provides an exhaust gas recirculation device for a gas turbine engine (10), comprising: an exhaust gas recirculation passage (32) for supplying a part of exhaust gas discharged from a combustor (18) of a gas turbine engine to the combustor; an air-cooled cooler (34) provided in the exhaust gas recirculation passage for cooling the exhaust gas flowing through the exhaust gas recirculation passage by heat exchange with ambient air; and an oil-cooled cooler (36) provided in the exhaust gas recirculation passage for cooling the exhaust gas flowing through the exhaust gas recirculation passage by heat exchange with lubricating oil of the gas turbine engine.

By thus using both the air-cooled cooler and the oil-cooled cooler, the recirculated exhaust gas can be cooled to a required temperature without undesirably increasing the size and weight of the cooling device.

Preferably, the air-cooled cooler is positioned upstream of the oil-cooled cooler with respect to flow of the recirculated exhaust gas.

Thus, the recirculated exhaust gas is first cooled by ambient air, and then cooled by the lubricating oil so that the recirculated exhaust gas can be cooled to a desired extent while minimizing the overall size and weight of the cooling system consisting of the oil-cooled cooler and the air-cooled cooler

Preferably, the gas turbine engine is provided with a duct (44), and a fan (48) driven by a power source to force air to flow through the duct, and the air-cooled cooler is configured to be cooled by the air flowing through the duct.

Thereby, the exhaust gas cooling efficiency of the air-cooled cooler is improved, and the size of the air-cooled cooler is reduced. Furthermore, the temperature drop in the exhaust gas owing to the air-cooled cooler may be increased such that the size of the oil-cooled cooler is reduced.

Preferably, the air-cooled cooler and the oil-cooled cooler are arranged along an outer periphery of the gas turbine engine circumferentially one next to another.

Thereby, the air-cooled cooler and the oil-cooled cooler can be provided outside the gas turbine engine without excessively radially protruding from a circular outer profile of the gas turbine engine.

The present invention thus provides an exhaust gas cooling device for a gas turbine engine that can cool the recirculated exhaust gas to a required temperature without undesirably increasing the size and weight of the cooling device.

### BRIEF DESCRIPTION OF THE DRAWING

FIG. 1 is a schematic diagram of a gas turbine engine fitted with an exhaust gas recirculation device according to an embodiment of the present invention;

FIG. 2 is a simplified vertical sectional view of the gas turbine engine; and

FIG. 3 is an end view of the gas turbine engine partly in section.

### DESCRIPTION OF THE PREFERRED EMBODIMENT(S)

A gas turbine engine fitted with an exhaust gas recirculation device according to an embodiment of the present invention will be described in the following with reference to the appended drawings.

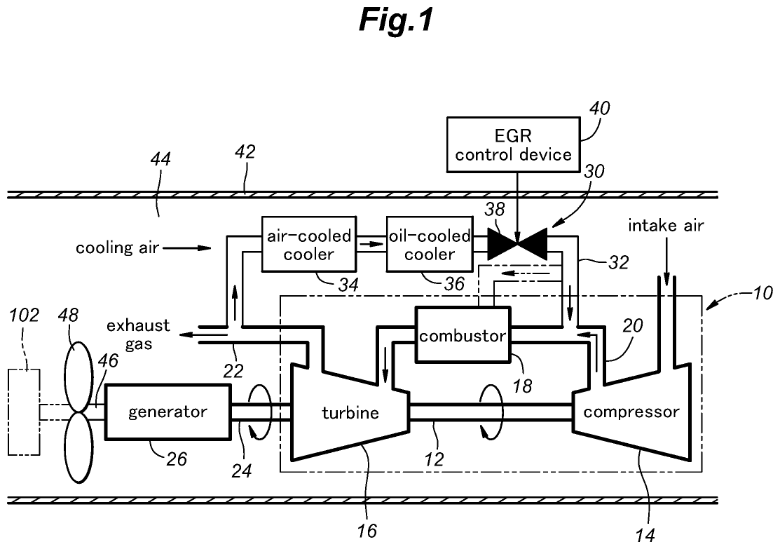

FIG. 1 shows the overall structure of the gas turbine engine.

The gas turbine engine 10 is provided with a compressor 14 and a turbine 16 which are coaxially connected to each other by a rotating shaft 12. The compressor 14 compresses intake air drawn from the atmosphere, and supplies the compressed intake air to a combustor 18 via an intake passage 20. Fuel is injected into the combustor 18 from a fuel source not shown in the drawings in a per se known manner, and mixed with the intake air. The mixture is combusted in the combustor 18 to generate high pressure combustion gas. The combustion gas is introduced into the turbine 16, and rotationally drives the turbine 16. The combustion gas is then discharged to the atmosphere from an exhaust gas passage 22 as exhaust gas.

A generator 26 is connected to the output shaft 24 of the turbine 16 via an output shaft 24 which is coaxially connected to the rotating shaft 12 in a torque transmitting relationship. As a result, the generator 26 is rotationally driven by the gas turbine engine 10 to generate electric power. Thus, the gas turbine engine 10 and the generator 26 jointly form a gas turbine engine power generating plant

An exhaust gas recirculation device 30 is attached to the gas turbine engine 10. The exhaust gas recirculation device 30 has a recirculated exhaust gas passage 32 that supplies a part of the exhaust gas (recirculated exhaust gas) from the exhaust gas passage 22 to the intake passage 20 which connects the outlet of the compressor 14 to the combustor 18. The recirculated exhaust gas passage 32 is provided with an air-cooled cooler 34, an oil-cooled cooler 36, and an EGR control valve 38 in this order from the upstream side with respect to the flow direction of the recirculated exhaust gas flowing through the recirculated exhaust gas passage 32.

The air-cooled cooler 34 cools the recirculated exhaust gas flowing through the recirculated exhaust gas passage 32 by heat exchange with ambient air (cooling air). The air-cooled cooler 34 may consist of a shell and tube heat exchanger, a plate fin heat exchanger or any other per se known air-cooled heat exchanger.

The recirculated exhaust gas cooled by the air-cooled cooler 34 is then cooled by the oil-cooled cooler 36 which is located immediately downstream of the air-cooled cooler 34.

The oil-cooled cooler 36 cools the recirculated exhaust gas flowing through the recirculated exhaust gas passage 32 by heat exchange with the lubricating oil of the gas turbine engine 10. The lubricating oil of the gas turbine engine 10 circulates inside the gas turbine engine 10 and lubricates the bearings of the rotating parts and other moving parts of the gas turbine engine 10. The lubricating system of the gas turbine engine 10 is provided with an oil tank, a piping system and a pump (not shown in the drawings) which, in a per se known manner, circulates the lubricating oil to various parts of the gas turbine engine 10. The lubricating oil for the oil-cooled cooler 36 may be drawn from the outlet end of the oil tank. Alternatively, the lubricating oil for the oil-cooled cooler 36 may be drawn from the part of the lubricating system immediately upstream of the oil tank. The oil-cooled cooler 36 may consist of a shell and tube heat exchanger, a double pipe heat exchanger, a plate heat exchanger, or any other per se known oil-cooled heat exchanger.

The EGR control valve 38 consisting of an electromagnetic valve is provided in a part of the recirculated exhaust gas passage 32 downstream of the oil-cooled cooler 36, and adjusts the flow of the recirculated exhaust gas under the control of an EGR control unit 40 in a per se known manner.

Thus, the recirculated exhaust gas flowing through the recirculated exhaust gas passage 32 is first cooled by the air-cooled cooler 34 and then cooled by the oil-cooled cooler 36, and the flow rate of the recirculated exhaust gas is adjusted by the EGR control valve 38 under the control of the EGR control unit 40.

The gas turbine engine 10 is provided with a tubular shell 42 which surrounds the gas turbine engine 10, and defines a fan duct (cooling air passage) 44 having an annular cross section jointly with the main body of the gas turbine engine 10. The air-cooled cooler 34 and an oil-cooled cooler 36 are positioned in the fan duct 44.

A blower fan 48 that is rotationally driven by a rotating shaft 46 of the generator 26, or in other words, by the output shaft 24 of the turbine 16 is provided in the fan duct 44. The blower fan 48 creates a cooling air flow in the fan duct 44, and this cooling air flow is used by the air-cooled cooler 34 to cool the recirculated exhaust gas.

As a result, the cooling efficiency of the air-cooled cooler 34 is improved, and the size of the air-cooled cooler 34 can be reduced. Thus, the recirculated exhaust gas is cooled by the air-cooled cooler 34 to such an extent that the necessary capability or the size of the oil-cooled cooler 36 can be reduced.

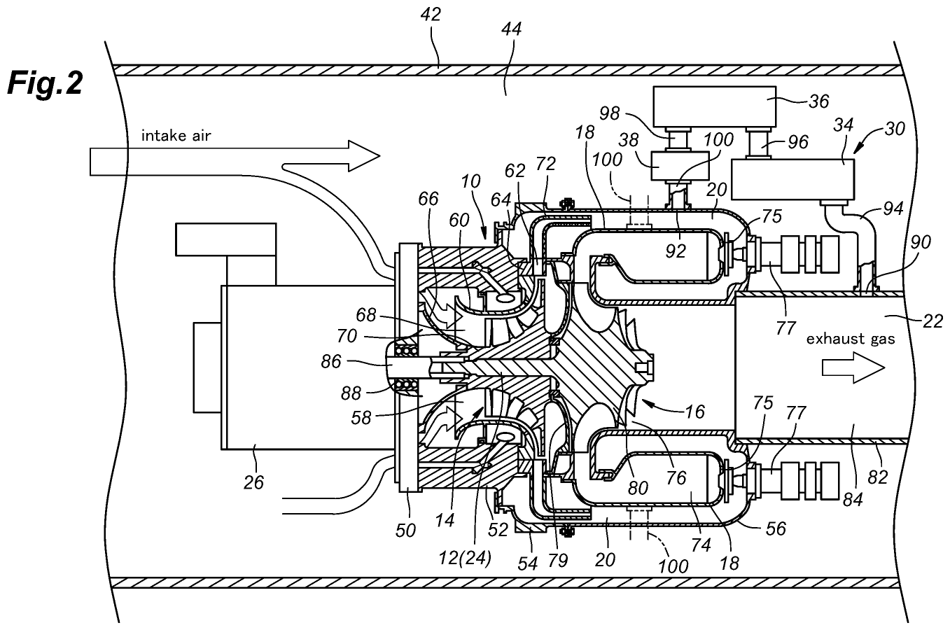

The structure of the gas turbine engine to which the exhaust gas recirculation device of this embodiment is applied will be described in the following with reference to FIG. 2.

The gas turbine engine 10 has a front end plate 50, a front housing 52, an intermediate housing 54, and a rear housing 56 which are axially connected to one another in this order.

The compressor 14 is of the centrifugal type, and is provided with a compressor housing 60 which is received in and secured to the front housing 52. The compressor housing 60 internally defines a compressor chamber 58 therein. A compressor wheel 70 is attached to the rotating shaft 12, and is positioned in the compressor chamber 58. An air intake guide member 66 is supported by the front end plate 50 so as to define an air intake passage 68 jointly with a front end part of the compressor housing 60. A compressed air outlet member 64 internally defining a compressed air outlet 62 is attached to the rear end of the compressor housing 60.

A diffuser 72 is provided in the rear end of the compressed air outlet member 64. A combustor 18 is provided in the rear housing 56 in an annular configuration. The combustor 18 may be a fully annular combustor, or a can-type combustor including a plurality of individual can combustors arranged in an annular pattern. The combustor 18 internal defines a combustion chamber 74, and is provided with a plurality of fuel injection nozzles 77 for injecting fuel into the combustion chamber 74. In this case, the fuel injection nozzles 77 are provided in the rear end of the combustor 18.

In the combustion chamber 74, the mixture of the fuel injected into the combustion chamber 74 by the injection nozzles 77 and the intake air supplied from the compressor 14 is combusted to generate high-pressure combustion gas.

The turbine 16 of this embodiment of a centrifugal type, and the rear housing 56 internally defines a turbine chamber 76 for the turbine 16. The turbine chamber 76 is separated from the compressor chamber 58 by a partition member 79 through which the rotating shaft 12 is passed via a suitable sealing structure. The part of the rotating shaft 12 located in the turbine chamber 76 is fixedly fitted with a turbine wheel 80.

Thus, the intake air admitted from the air intake passage 68 is compressed by the compressor wheel 70 in the compressor chamber 58, and forwarded to the diffuser 72 via the compressed air outlet 62. The compressed air is then supplied to the combustion chamber 74 and causes the combustion of fuel in the combustion chamber 74. The combustion gas is discharged from the combustion chamber 74, impinges upon the turbine wheel 80 in the turbine chamber 76, and rotationally drives the turbine wheel 80. The combustion gas is discharged from the turbine chamber 76 to the atmosphere via an exhaust passage 84 which is internally defined by the exhaust pipe 82 connected to the rear end of the rear housing 56.

The generator 26 is provided with a rotor shaft 86 which is passed through the front end plate 50 via a bearing 88, and is coaxially connected to the rotating shaft 12 in a torque transmitting relationship. In this embodiment, the rotating shaft 12 and the rotor shaft 86 are rotatably supported solely by the front end plate 50 via the bearing 88.

The exhaust pipe 82 is provided with an exhaust gas inlet port 90 for drawing a part of the exhaust gas flowing through the exhaust gas passage 22 as recirculated exhaust gas. An exhaust gas outlet port 92 is provided in the rear housing 56 for introducing the recirculated exhaust gas into the intake passage 20. An air-cooled cooler 34 is connected to the exhaust gas inlet port 90 via a recirculated exhaust gas supply pipe 94. The outlet end of the air-cooled cooler 34 is connected to the inlet end of the oil-cooled cooler 36 via a recirculated exhaust gas supply pipe 96. The outlet end of the oil-cooled cooler 36 is connected to the inlet end of the EGR control valve 38 via a recirculated exhaust gas supply pipe 98. The outlet end of the EGR control valve 38 is connected to the exhaust gas outlet port 92 via a recirculated exhaust gas supply pipe 100.

Thus, a small part of the exhaust gas flowing through the exhaust passage 84 is drawn from the exhaust gas inlet port 90, and is forwarded, via the recirculated exhaust gas supply pipe 94, the air-cooled cooler 34, the recirculated exhaust gas supply pipe 96, the oil-cooled cooler 36, and the recirculated exhaust gas supply pipe 98, the EGR control valve 38 and the recirculated exhaust gas supply pipe 100, to the exhaust gas outlet port 92 to be supplied to the intake passage 20.

The recirculated exhaust gas supplied to the intake passage 20 is passed to the combustion chamber 74 together with the intake air flowing through the intake passage 20. As a result, NOx in the combustion gas or the exhaust gas can be reduced.

The recirculated exhaust gas drawn from the exhaust gas inlet port 90 to the recirculated exhaust gas supply pipe 94 is first cooled by the air-cooled cooler 34, and thereafter cooled by the oil-cooled cooler 36.

As a result, the recirculated exhaust gas is cooled to a required temperature with a minimum size requirement as compared to the case where only the air-cooled cooler 34 or only the oil-cooled cooler 36 is used.

The oil-cooled cooler 36 provides a higher heat transfer coefficient as compared with the air-cooled cooler 34 for the given size, but is unable to deal with a high heat duty without increasing the flow rate of the cooling medium or oil. This inevitably increases the weight of the cooler, and the pumping load for circulating the cooling medium. The air-cooled cooler 34 provides a relatively low heat transfer coefficient, but is able to deal with a high heat duty without substantially increasing the weight of the cooler. The air-cooled cooler 34 is generally lighter in weight as compared with the oil-cooled cooler 36 so that even if the air-cooled cooler 34 is increased in size, the resulting increase in weight is comparatively small as compared to the case of increasing the size of the oil-cooled cooler 36. Therefore, by suitably selecting the sizes of the air-cooled cooler 34 and the oil-cooled cooler 36 for the given heat transfer requirement, the desired cooling of the recirculated exhaust gas can be accomplished while minimizing the overall weight of the cooling arrangement.

Since the exhaust gas is cooled by the air-cooled cooler 34 before being introduced into the oil-cooled cooler 36, the cooling load on the oil-cooled cooler 36 is more reduced as compared to the case where the air-cooled cooler 34 is positioned downstream of the oil-cooled cooler 36 or there is no air-cooled cooler at all. Thus, the size of the oil-cooled cooler 36 is prevented from becoming undesirably large, and the temperature of the lubricating oil is prevented from becoming excessively high.

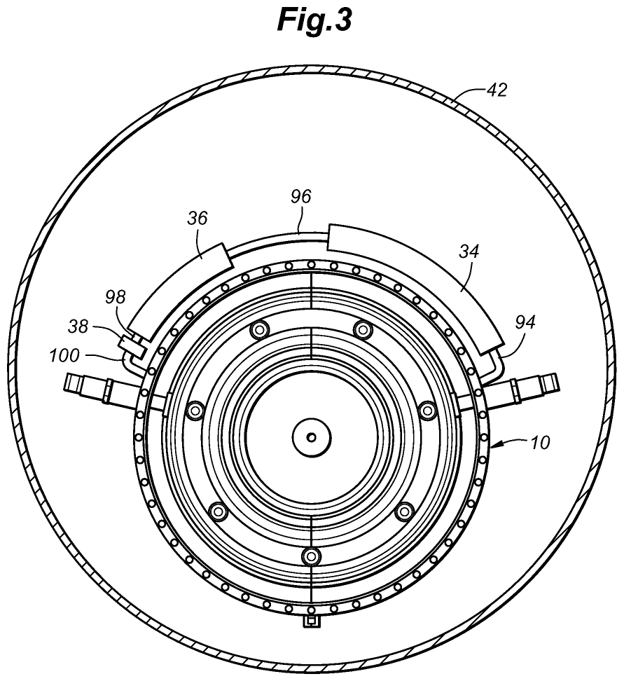

FIG. 3 shows the layout of the air-cooled cooler 34 and the oil-cooled cooler 36 in the gas turbine engine 10.

As shown in FIG. 3, the air-cooled cooler 34, the oil-cooled cooler 36 and the EGR control valve 38 are arranged along the outer periphery of the main part of the gas turbine engine 10 or along the circumferential direction of the gas turbine engine 10. In particular, the air-cooled cooler 34, the oil-cooled cooler 36 and the EGR control valve 38, along with the recirculated exhaust gas supply pipes 94, 96, 98 and 100, are positioned closely along the outer periphery of the main part of the gas turbine engine 10. As a result, the radial dimensions of the gas turbine engine 10 can be minimized. Preferably, the air-cooled cooler 34 and/or the oil-cooled cooler 36 may be curved so as to conform to the arcuate outer profile of the main part of the gas turbine engine 10.

The present invention has been described in terms of a specific embodiment, but the present invention is not limited by such embodiments and can be modified in various ways without departing from the scope of the present invention. Moreover, not all of the constituent elements shown in the above embodiments are essential to the broad concept of the present invention, and they can be appropriately selected, omitted and substituted without departing from the gist of the present invention. For example, the recirculated exhaust gas may be supplied directly to the combustion chamber 74 instead of the intake passage 20 by a recirculated exhaust gas supply pipe 100 as shown in phantom lines in FIG. 1. Also, the blower fan 48 may be rotationally driven by an electric motor 102 as indicated by the phantom lines in FIG. 1, instead of being driven by the rotating shaft 46 which is driven by the rotating shaft 12 of the turbine 16. The contents of any cited references in this disclosure will be incorporated in the present application by reference.

1. An exhaust gas recirculation device for a gas turbine engine, comprising:
an exhaust gas recirculation passage for supplying a part of exhaust gas discharged from a combustor of a gas turbine engine to the combustor;
an air-cooled cooler provided in the exhaust gas recirculation passage for cooling the exhaust gas flowing through the exhaust gas recirculation passage by heat exchange with ambient air; and
an oil-cooled cooler provided in the exhaust gas recirculation passage for cooling the exhaust gas flowing through the exhaust gas recirculation passage by heat exchange with lubricating oil of the gas turbine engine.

2. The exhaust gas recirculation device according to claim 1, wherein the air-cooled cooler is positioned upstream of the oil-cooled cooler with respect to flow of the recirculated exhaust gas.

3. The exhaust gas recirculation device according to claim 1, wherein the gas turbine engine is provided with a duct, and a fan driven by a power source to force air to flow through the duct, and the air-cooled cooler is configured to be cooled by the air flowing through the duct.

4. The exhaust gas recirculation device according to claim 1, wherein the air-cooled cooler and the oil-cooled cooler are arranged along an outer periphery of the gas turbine engine circumferentially one next to another.
